(19) United States
(12) Patent Application Publication
(10) Pub. No.: US 2014/0059489 A1
(43) Pub. Date: Feb. 27, 2014

(54) Rotate Gesture

(71) Applicants: Kenneth J. Klask, San Jose, CA (US); James R. Weber, San Ramon, CA (US)

(72) Inventors: Kenneth J. Klask, San Jose, CA (US); James R. Weber, San Ramon, CA (US)

(73) Assignee: AMULET TECHNOLOGIES, LLC, Campbell, CA (US)

(21) Appl. No.: 13/590,283

(22) Filed: Aug. 21, 2012

(51) Int. Cl. G06F 3/048

(52) U.S. Cl. 715/825

(57) ABSTRACT

A method for a user interface includes displaying a first item from a list of items on a screen, detecting, using a processor, a gesture comprising a circular motion, and, in response to detecting the gesture, displaying a second item from the list of items on the screen in place of the first item.

### BACKGROUND

Computing devices may have user interfaces that utilize gestures. A gesture may be received through a human machine interface, including but limited to a touchpad or a touchscreen, and interpreted by a controller or processor. Alternatively a gesture may be captured in three-dimensional space by cameras or other input devices and interpreted by a controller or processor.

### BRIEF DESCRIPTION OF THE DRAWINGS

In the drawings:

FIGS. 1 and 2 illustrate a use of a rotate gesture to change a time of day displayed on a touchscreen in one example of the present disclosure;

FIG. 3 illustrates a use of the rotate gesture in three-dimensional (3D) space to change a time of day displayed on a screen in one example of the present disclosure;

FIG. 4 illustrates a use of the rotate gesture to change a menu option displayed on a touchscreen in one example of the present disclosure;

FIG. 5 is a block diagram of a computing device for implementing a user interface with the rotate gesture in one example of the present disclosure; and

FIG. 6 is a flowchart of a method to implement the user interface with the rotate gesture in one example of the present disclosure.

Use of the same reference numbers in different figures indicates similar or identical elements.

### DETAILED DESCRIPTION

In examples of the present disclosure, a rotate gesture with a circular motion is used to scroll through items on a screen. One turn may yield one or more rotational events. Performing the rotate gesture in a clockwise direction scrolls through the items in a first manner (e.g., in an incrementing order or in a first direction) while performing the rotate gesture in a counterclockwise direction scrolls through the items in a second manner (e.g., in a decrementing order or in a second direction). The rotate gesture may be performed with one or multiple fingers.

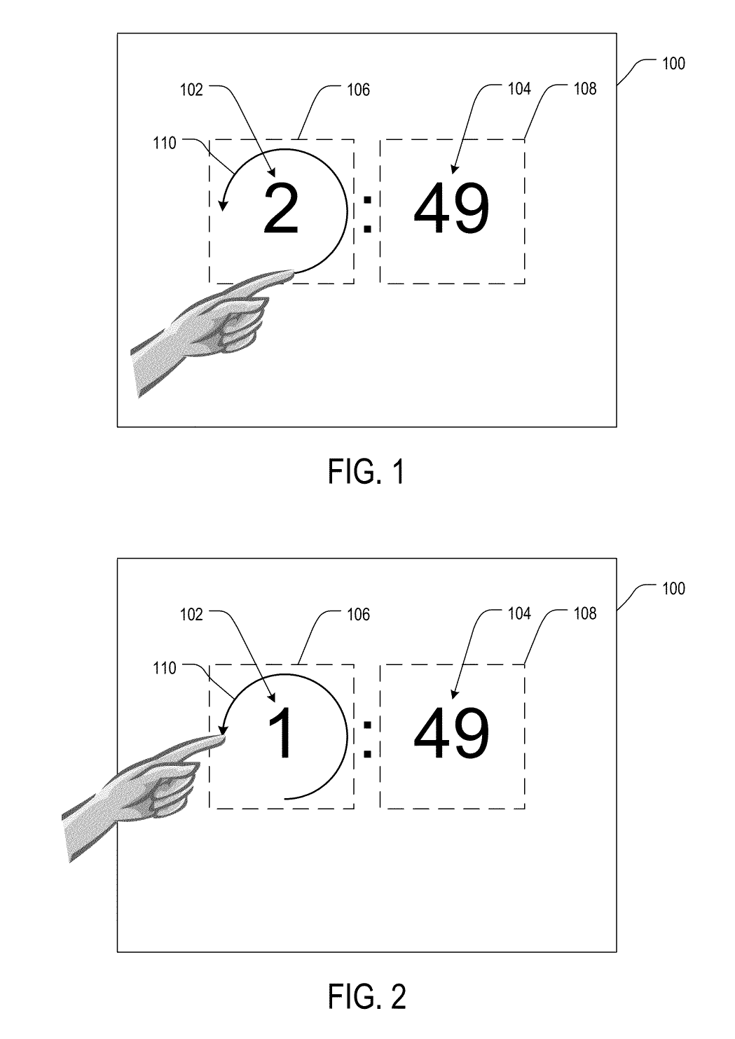

FIGS. 1 and 2 illustrate a use of the rotate gesture to change a time of day displayed on a touchscreen 100 in one example of the present disclosure. Touchscreen 100 includes a screen and a touch sensor for receiving user input. In other examples, touchscreen 100 may be replaced with a screen and a user input device such as a touchpad or a mouse that receives user input.

For the example in FIGS. 1 and 2, touchscreen 100 displays the time of the day with the hour 102 and the minute 104. The user performs the single finger rotate gesture in a designated area 106 on touchscreen 100 to scroll through the values of the hour 102 (e.g., 0 to 12 or 24), and the user performs the rotate gesture in a designated area 108 on touchscreen 100 to scroll through the values of the minute 104 (e.g., 0 to 60). Although each area is illustrated as being a square area centered about a displayed value, the area may be another shape to allow the user to provide the single finger rotate gesture adjacent to the displayed values.

The user provides a clockwise circular motion to scroll through the values of the hour 102 or the minute 104 in an incrementing order for each clockwise rotational event, and a counterclockwise circular motion to scroll through the values of the hour 102 or the minute 104 in a decrementing order for each counterclockwise rotational event, or vice versa. FIGS. 1 and 2 illustrates the user providing a counterclockwise circular motion 110 in area 106 to decrement the value of the hour 102 from 2 to 1 o'clock. The user may also use the rotate gesture in area 108 to change the minute 104.

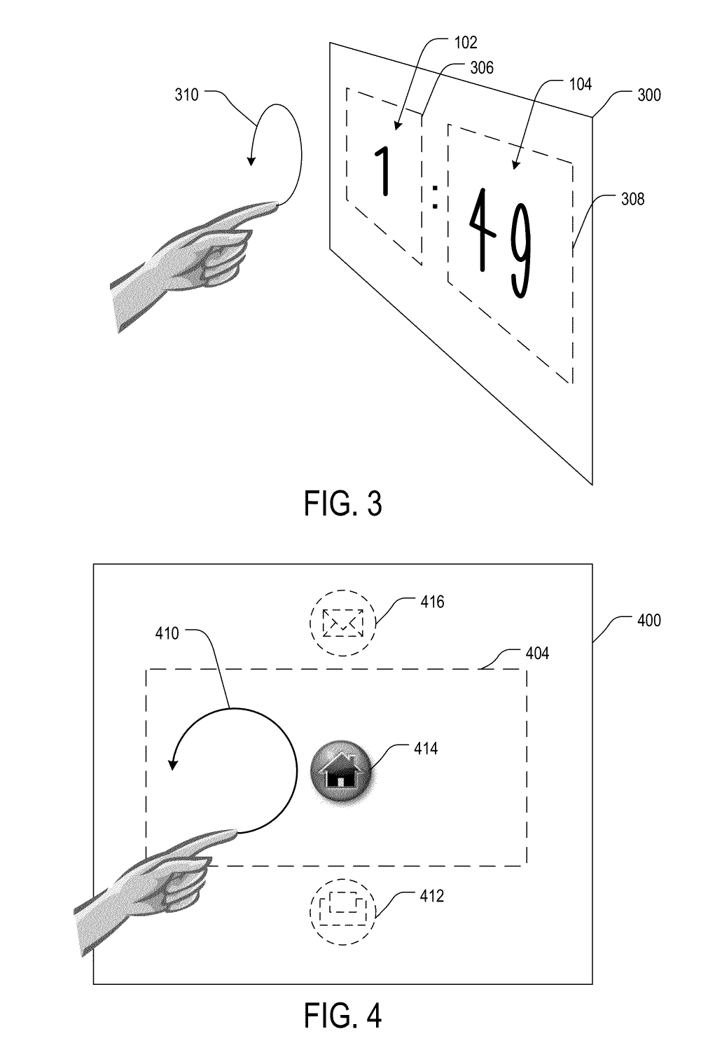

FIG. 3 illustrates a use of the rotate gesture in three-dimensional (3D) space to change a time of day displayed on a screen 300 in one example of the present disclosure. For this example, screen 300 displays the time of the day with the hour 102 and the minute 104. The user performs the rotate gesture with circular motion 310 in the 3D space over a designated area 306 on screen 300 to scroll through the values of the hour 102, and the user performs the rotate gesture in the 3D space over a designated area 308 to scroll through the values of the minute 104. Although each area is illustrated as being a square area centered about a displayed value, the area may be another shape to allow the user to provide the rotate gesture adjacent to the displayed value. The user provides a clockwise circular motion to increment the value of the hour 102 or the minute 104 for each clockwise rotational event, and a counterclockwise circular motion to decrement the value of the hour 102 or the minute 104 for each counterclockwise rotational event, or vice versa.

FIG. 4 illustrates a use of the rotate gesture to change a menu option displayed on a touchscreen 400 in one example of the present disclosure. In other examples, touchscreen 400 may be replaced with a screen and a user input device such as a touchpad or a mouse that receives user input.

For the example in FIG. 4, touchscreen 400 displays a menu option 414 selected from menu options 412 (shown in phantom), 414, and 416 (shown in phantom). Menu options 412 and 416 may not be visible or they may appear faded as they are not selected. The user performs the rotate gesture with a circular motion 410 in a designated area 404 on touchscreen 400 to scroll through menu option 412, 414, and 416. Area 404 may be extended so the user may provide the rotate gesture adjacent to the selected option 402. The user provides a clockwise circular motion scroll through options 412, 414, and 416 in one direction (e.g., to show the subsequent menu option 416) for each clockwise rotational event, and a counterclockwise circular motion to scroll through options 412, 414, and 416 in another direction (to shown the previous menu option 412) for each counterclockwise rotational event, or vice versa.

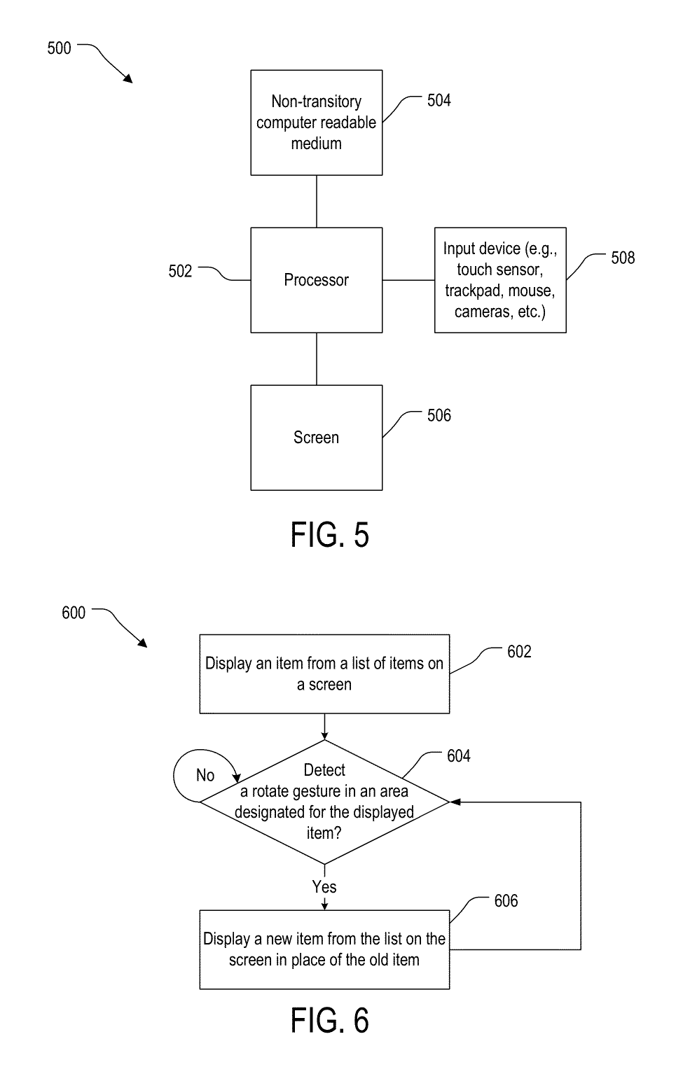

FIG. 5 is a block diagram of a computing device 500 for implementing a user interface with the rotate gesture in one example of the present disclosure. Computing device 500 includes a processor 502 that executes instructions 504 stored in a non-transitory computer readable medium, such as a hard disk drive or a solid state drive. Computer executable instructions 504 implement the user interface including gestures such as the rotate gesture. Processor 502 provides the user interface on a screen 506. Processor 502 captures user input through an input device 508 and decodes the user input as a gesture. In one example, input device 508 is a touch sensor that forms part of a touchscreen for receiving single or multi-touch input from the user. In another example, input device 508 is a touchpad or a mouse. In yet another example, input device 508 is stereoscopic cameras for capturing 3-D user input.

Processor 502 may project the gesture onto screen 506 to determine if the gesture is performed in a designated area for a displayed item.

FIG. 6 is a flowchart of a method 600 to implement the user interface with the rotate gesture in one example of the present disclosure. Method 600 may begin in block 602.

In block 602, processor 502 (FIG. 5) displays an item from a list of items on screen 506 (FIG. 5). For example, the displayed item may be a value of all the values for the hour of the day as shown in FIG. 1. Block 602 may be followed by block 604.

In block 604, processor 502 determines if it detects a rotate gesture in an area designated for the displayed item. For example, processor 502 determines if the user made a rotate gesture with circular motion 110 in area 106 designated for the value of the hour 102 on touchscreen 100 as shown in FIG. 1. If processor 502 determines a rotate gesture is detected in the area designated for the displayed item, block 604 is followed by block 606. Otherwise block 604 loops back to itself.

In block 606, processor 502 displays a new item from the list in place of the old item on the screen based on the number of rotational events. For example, the old value of the hour of the day is replaced with a new, greater or smaller value of the hour of the day as shown in FIG. 2. Block 606 may be followed by block 604.

Various other adaptations and combinations of features of the examples disclosed are within the scope of the invention. Numerous examples are encompassed by the following claims.

What is claimed is:

1: A method for providing a user interface, comprising:
displaying on a screen a first item from a list of items;
detecting, using a processor, a gesture comprising a circular motion; and
in response to detecting the gesture, displaying on the screen a second item from the list of items in place of the first item.

2: The method of claim 1, wherein one turn of the circular motion comprises one or more rotational events, and the second item is based on a number of the rotational events.

3: The method of claim 1, wherein the screen comprises a touchscreen and the gesture is a touch gesture performed on the touchscreen.

4: The method of claim 1, wherein detecting the gesture comprises detecting the gesture in an area on the screen designated for scrolling through the list of items.

5: The method of claim 1, wherein the list of items comprises values for the hour or the minute of a day.

6: The method of claim 1, wherein the second item is greater than the first item in value when the circular movement comprises a clockwise movement and the second item is lesser than the first item in value when the circular movement comprises a counterclockwise movement.

7: The method of claim 1, wherein the second item is lesser than the first item in value when the circular movement comprises a clockwise movement and the second item is greater than the first item in value when the circular movement comprises a counterclockwise movement.

8: The method of claim 1, wherein the gesture is a three-dimensional gesture performed in a space before the screen.

9: The method of claim 1, wherein the list of items comprises menu options, the second item comprises a subsequent menu option when the circular movement comprises a clockwise movement, and the second item comprises a prior menu option when the circular movement comprises a counterclockwise movement.

10: The method of claim 1, wherein the list of items comprises menu options, the second item comprises a prior menu option when the circular movement comprises a clockwise movement, and the second item comprises a subsequent menu option when the circular movement comprises a counterclockwise movement.

11: An apparatus, comprising:
a screen;
a processor to:
display on the screen a first item from a list of items;
detect a gesture comprising a circular motion; and
in response to the gesture, display on the screen a second item from the list of items in place of the first item.

12: The apparatus of claim 11, wherein one turn of the circular motion comprises one or more rotational events, and the second item is based on a number of the rotational events.

13: The apparatus of claim 11, wherein the screen comprises a touchscreen and the gesture is a touch gesture performed on the touchscreen.

14: The apparatus of claim 11, wherein detect the gesture comprises detect the gesture in an area on the screen designated for scrolling through the list of items.

15: The apparatus of claim 11, wherein the list of items comprises values for the hour or the minute of a day.

16: The apparatus of claim 11, wherein the second item is greater than the first item in value when the circular movement comprises a clockwise movement and the second item is lesser than the first item in value when the circular movement comprises a counterclockwise movement.

17: The apparatus of claim 11, wherein the second item is lesser than the first item in value when the circular movement comprises a clockwise movement and the second item is greater than the first item in value when the circular movement comprises a counterclockwise movement.

18: The apparatus of claim 11, wherein the gesture is a three-dimensional gesture performed in a space before the screen.

19: The apparatus of claim 11, wherein the list of items comprises menu options, the second item comprises a subsequent menu option when the circular movement comprises a clockwise movement, and the second item comprises a prior menu option when the circular movement comprises a counterclockwise movement.

20: The apparatus of claim 11, wherein the list of items comprises menu options, the second item comprises a prior menu option when the circular movement comprises a clockwise movement, and the second item comprises a subsequent menu option when the circular movement comprises a counterclockwise movement.
